(19) United States
(12) Patent Application Publication
(10) Pub. No.: US 2010/0114787 A1
(43) Pub. Date: May 6, 2010

(54) Internet based personality and compatibility profiling through handwriting analysis

(76) Inventor: Michael Stephen Kahlowsky, Tamarac, FL (US)

Correspondence Address: Michael Kahlowsky, 9150 Whistable Walk, TAMARAC, FL, 33321, US

(21) Appl. No.: 12/228,856

(22) Filed: Aug. 18, 2008

Related U.S. Application Data
(60) Provisional application No. 60/997,116, filed on Oct. 1, 2007.

(51) Int. Cl. G06Q 99/00; G06Q 90/00

(52) U.S. Cl. 705/319; 705/500

(57) ABSTRACT

Described herein is a method and system for identifying compatibility traits and corresponding levels of compatibility by trait through handwriting analysis. Subscribers or users of the profiling and dating service will take an internet based (online) handwriting analysis personality and compatibility test. Once the user completes the handwriting analysis test, they will instantaneously receive personality and compatibility information about themselves. The user will then have the opportunity to invite other friends, family members, significant others, dates, acquaintances, or any other individual to take the internet based handwriting analysis personality and compatibility test. Upon completion of the internet based handwriting analysis personality and compatibility test by the inviter and the invitee, instantaneous personality and compatibility comparison information will be displayed.

### CROSS REFERENCE TO RELATED APPLICATIONS

This application claims priority to provisional application Ser. No. 60/997,116 with filing date of Oct. 10, 2007 and title “internet based personality and compatibility profiling through handwriting analysis.”

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

There are many personality profiling systems in place today. However, there are not any personality and compatibility profiling systems in place today that use handwriting analysis as the basis for instantaneously producing compatibility outlooks between two individuals. The system outlined in this invention utilizes handwriting analysis, in particular, the Gestalt handwriting analysis school-of-thought as the basis for generating instantaneous personality and compatibility results.

### BRIEF SUMMARY OF THE INVENTION

This invention is an internet based (online) handwriting analysis based personality and compatibility profiling service that instantaneously produces personality and compatibility results that connect and match users.

### BRIEF DESCRIPTION OF THE SEVERAL VIEWS OF THE DRAWING

Not applicable

### DETAILED DESCRIPTION OF THE INVENTION

This internet based (online) handwriting analysis based personality and compatibility profiling service instantaneously produces personality and compatibility results that connect and match users. The process for producing these results, connecting and matching users is as follows:
1. Handwriting analysis guidelines and instructions are provided to the subscriber/user prior to taking the internet based (online) handwriting analysis personality and compatibility test.
2. A set of handwriting analysis test questions and corresponding available answers are provided to the user to choose from. A handwriting analysis tip is provided for each test question to clarify any questions the user may have about the test question.
3. An explanatory write-up on handwriting analysis and compatibility that helps users/subscribers understand compatibility and the compatibility traits that can be evaluated through handwriting analysis is provided after the handwriting analysis test questions are completed. This write-up also helps users/subscribers become aware of important compatibility traits that can not be evaluated through handwriting analysis.
4. A handwriting analysis software algorithm developed by the inventor, utilizes the handwriting analysis “Gestalt” school-of-thought to instantaneously produce unique personality and compatibility trait information for users/subscribers.
5. Over 141,000 unique compatibility combinations produce corresponding outlooks that exist between two individuals (inviter and invitee). The compatibility outlooks of Great, Upbeat, Manageable and Too Much of a Stretch are interchangeable with Fantastic, Favorable, Acceptable and Sketchy.
6. A Personality Scoring System Legend identifies the unique personality categories that are generated from the handwriting analysis software algorithm and a Compatibility Scoring System Legend identifies the unique compatibility outlooks. These legends are available to users/subscribers.
7. A Comprehensive Personality and Compatibility Report which includes the following sections on personality and/or compatibility is available to users/subscribers: Disposition, Emotional Expression, Outlook, Sexual Interest and Energy/Emotional Capacity, Emotional Maturity, Attitude, Thought Process, Intellect, Tense Orientation

What is claimed is:

1. In an internet based profiling service, a handwriting analysis based software algorithm provides benefits to users/subscribers which include:
1. Self growth opportunities identified through one's handwriting analysis
2. Compatibility matching identified by matching one user/subscriber to another user/subscriber through one's handwriting analysis
3. The personality and compatibility profile content has the potential to be licensed out to internet dating companies such as Match.com, EHarmony, etc. and social networking companies such as My Space, Facebook, etc. The internet dating and social networking members will be able to use the Handwriting Analysis test to search and match their personalities and compatibilities based on their handwriting to other internet dating and social networking members.
4. Also the personality and compatibility profile content has the potential to be used as the foundation for a dating web-site based on Handwriting Analysis.
